(19) United States
(12) Patent Application Publication
(10) Pub. No.: US 2026/0277564 A1
(43) Pub. Date: Sep. 17, 2026

(54) REINFORCEMENT LEARNING WITH TARGET FEEDBACK FOR SYNTHETIC DATA GENERATION

(71) Applicant: Optum, Inc., Minnetonka, MN (US)

(72) Inventors: Robert Elliott TILLMAN, Long Island City, NY (US); Melikasadat EMAMI, San Diego, CA (US); Jun HAN, New Hyde Park, NY (US); Xiaofeng LIN, Los Angeles, CA (US)

(21) Appl. No.: 19/246,139

(22) Filed: Jun. 23, 2025

Related U.S. Application Data
(60) Provisional application No. 63/771,766, filed on Mar. 14, 2025.

(51) Int. Cl. G06F 8/35

(52) U.S. Cl. CPC G06F 8/35

(57) ABSTRACT

Various embodiments of the present disclosure provide a synthetic data driven training scheme that improves the functionality of a computer in various aspects. The techniques comprise generating, using a code-specific generative model, a synthetic code sequence for training a code-specific classifier for a target code that is underrepresented within real world circumstances. The code-specific generative model may be trained using a direct preference loss function and preference training pairs that are generated from code sequences by splitting a code sequence into a prompt sequence and a continuation sequence, generating a positive training preference sample based on the prompt sequence and the continuation sequence, and generating a negative training preference sample by modifying a presence of the target code within the continuation sequence.

### CROSS REFERENCE TO RELATED APPLICATIONS

This application claims priority to U.S. Provisional Application No. 63/771,766, entitled Reinforcement Learning with Target Feedback for Synthetic Electronic Health Record Generation, filed Mar. 14, 2025, the entirety of which is incorporated by reference herein for all purposes.

### BACKGROUND

In many domains, large datasets are required to effectively train machine learning models. However, obtaining sufficient real-world data is challenging, especially for rare events or underrepresented categories within a domain. This phenomenon is known as data scarcity.

Traditional approaches to address data scarcity have included data augmentation techniques, such as oversampling or synthetic minority over-sampling techniques (SMOTE). These methods aim to artificially increase the representation of minority classes in the training data. However, they often struggle to generate diverse and realistic synthetic samples, particularly for complex structured data, such as sequences of codes or events.

Other approaches may rely on generative models, such as Generative Adversarial Networks (GANs), Variational Autoencoders (VAEs), and/or the like, to generate synthetic data. While these approaches may produce high-quality synthetic samples in some domains, they face limitations when dealing with discrete, sequential data or when attempting to accurately model specific events that are underrepresented within the data used to train the generative models. Ensuring that synthetic data maintains the correct relationships and distributions, especially for underrepresented features, remains a significant challenge.

### BRIEF DESCRIPTION OF THE DRAWINGS

FIG. 1 is a block diagram of an example architecture in accordance with some embodiments of the present disclosure.

FIG. 2 is a block diagram of an example predictive data analysis computing entity in accordance with some embodiments of the present disclosure.

FIG. 3 is a block diagram of an example client computing entity in accordance with some embodiments of the present disclosure.

FIG. 4 is a dataflow diagram of synthetic data driven training scheme in accordance with some embodiments of the present disclosure.

FIGS. 5A and B are operational examples of the direct preference training framework in accordance with some embodiments of the present disclosure.

FIG. 6 is a flowchart diagram of a direct preference training process in accordance with some embodiments of the present disclosure.

### DETAILED DESCRIPTION

Various embodiments of the present disclosure address technical challenges related to machine learning technology, particularly in the context of generating synthetic data for training classifiers. To do so, some embodiments of the present disclosure provide a direct preference training framework that defines a two-stage training approach for training a generative model by converting a direct preference learning object into a finetuning objective that addresses data scarcity. The two-stage training approach comprises a preference data generation stage and a preference alignment stage for a generative model. During the preference data generation stage, a preference training dataset is created that is specific to an underrepresented feature within a dataset (e.g., rather than human preferences) by adding targeted noise to data sequences within an original dataset. The targeted noise, for example, may add the underrepresented feature to data sequences that do not originally include the feature and remove the underrepresented feature from data sequences that do include the feature. The resulting “negative” data sequences may be combined with the original data sequences to form contrastive preference training pairs for a particular feature. During the preference alignment stage, the contrastive preference training pairs may be leveraged, with a direct preference loss function, to align a pre-trained generative model with a particular feature that is underrepresented within an original dataset. Once trained, a code-specific generative model may be used to generate synthetic training data for a feature that, due to its underrepresentation within an original dataset, traditionally could not support training a machine learning classifier. By doing so, the direct preference training framework enables the generation of synthetic training data that improves the scope, performance, and applicability of a downstream classifiers with respect to underrepresented features within a domain. In this manner, the direct preference training framework may adapt a preference training technique to a data scarcity solution that improves computer functionality, in general, by improving the training speeds and performance (e.g., in terms of the achievable accuracy and precision of the resulting models), and machine learning technology, in particular, by enhancing the scope and applicability of machine learning models to features (e.g., underrepresented features) traditionally outside its scope.

More particularly, some embodiments of the present disclosure provide a preference dataset that is tailored to an underrepresented feature, rather than a subjective preference, within a domain to provide contrastive training samples for a pre-trained generative model. To do so, a preference training pair may be generated that explicitly manipulates the presence of an underrepresented feature to provide a negative sample that may contrast with a positive counterpart with respect a single, targeted feature. By doing so, the preference dataset may provide a rich training signal that allows a generative model to learn the relationships that are specific to the underrepresented feature through a constructive learning objective. This, in turn, allows for the adaptation of preference learning objectives to a finetuning objective that may improve a generative model's output accuracy and diversity with respect underrepresented features within a domain, a task traditional models struggle to do.

In some embodiments, the preference dataset is combined with a direct preference optimization approach enable multiple training iterations that target multiple underrepresented features within a domain. For example, to overcome challenges in training reliable reward models for underrepresented features, the direct preference training framework may employ a direct preference optimization (DPO) objective within a finetuning (e.g., rather than preference alignment) training scheme. This technique directly uses preference-labeled data without requiring a separate reward model, making it more computationally efficient and effective for aligning a model's output with a particular feature despite a lack of data for the particular feature. In this manner, the techniques of the present disclosure may provide an efficient (e.g., in terms speed and compute requirements) training approach enabling the generation of synthetic data that achieves high fidelity to real-world distributions, while emphasizing the accurate generation of individually underrepresented features within the distributions. Moreover, the multiple variations of code-specific generative models, trained using the techniques of the present disclosure, may enable the creation of high-quality synthetic data that may be used to improve the downstream training of a variety of code-specific classifiers specific to features traditionally outside the scope of machine learning due to data scarcity. Ultimately, by generating more representative synthetic data, the techniques of the present disclosure enhance the capabilities of downstream machine learning tasks, which, in turn, improve decision-making processes in various technical fields that rely on machine learning analysis.

Examples of technologically advantageous embodiments of the present disclosure comprise a particular preference dataset structure and modifications to machine leaning mechanisms, such as direct preference learning mechanisms, that, among other aspects of the present disclosure, provide improvements to computer functionality and machine learning technology. Other technical improvements and advantages may be realized by one of ordinary skill in the art.

### I. Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### II. Example Framework

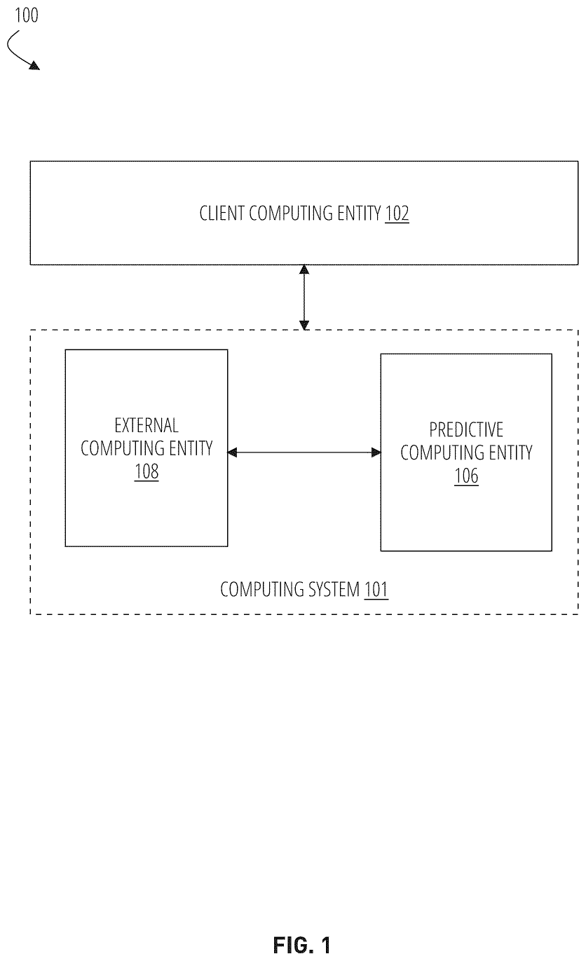

FIG. 1 depicts a block diagram of an example architecture 100 in accordance with some embodiments of the present disclosure. The architecture 100 comprises a computing system 101 configured to receive a request, such as a training request, synthetic data request, and/or the like, from client computing entities 102, process the request, and provide the responses, such as synthetic training data, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate outputs, such as synthetic data, preference data, and/or other machine learned outputs. The models may be adapted to underrepresented features within a domain through the unconventional training techniques of the present disclosure. For example, some techniques of the present disclosure may adapt traditional models that may be generic to a domain, to a targeted feature within the domain to improve the performance of the models with respect to events, features, or other elements of a domain that are rarely observed.

In some embodiments, the computing system 101 may communicate with at least one of the client computing entities 102 using one or more communication networks. Examples of communication networks comprise any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., data generation technique, training techniques, model alignment techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as code agnostic datasets, preference datasets, training datasets, and/or the like, to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### A. Example Computing Entity

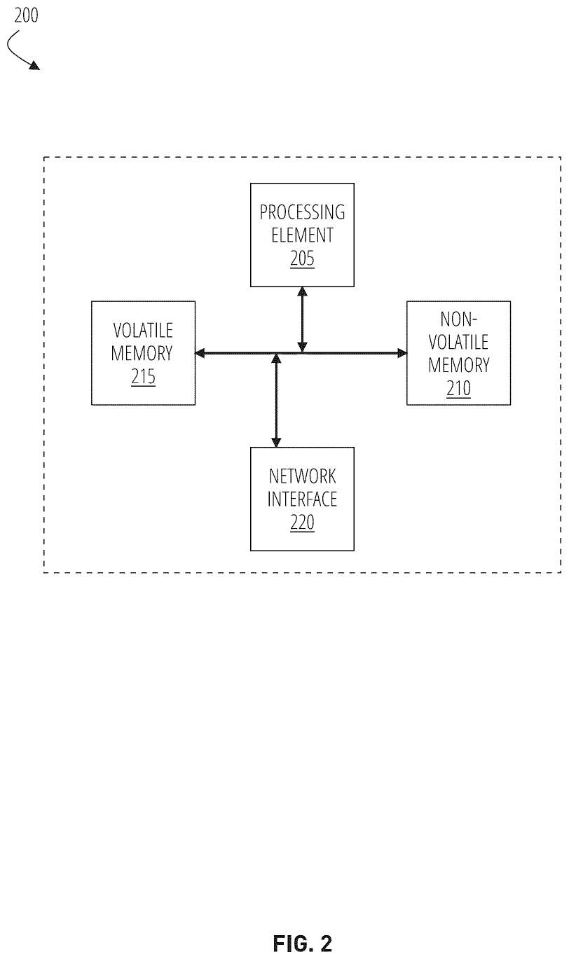

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium including random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### B. Example Client Computing Entity

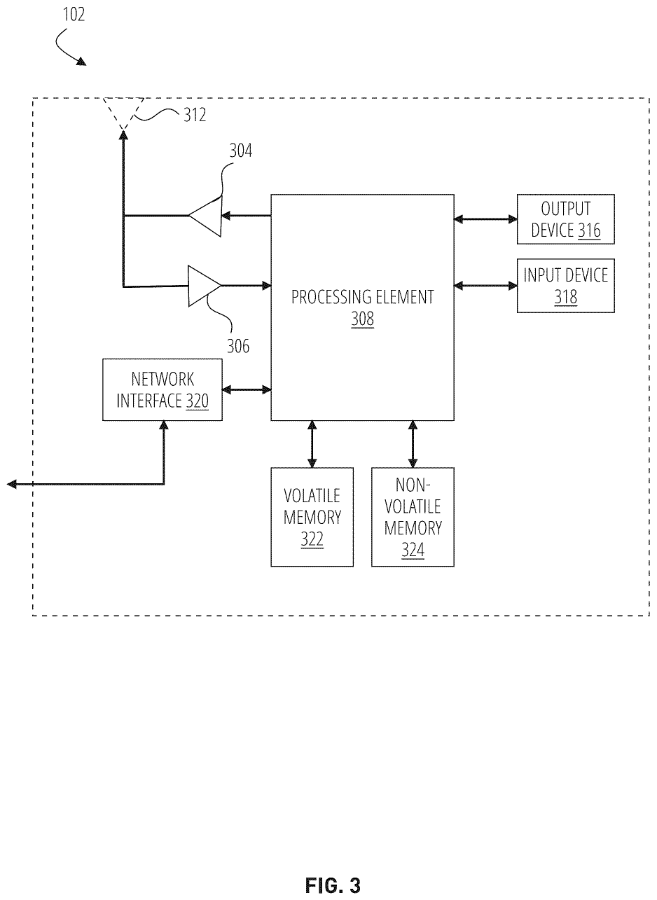

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### III. Example System Operations

As indicated, various embodiments of the present disclosure make important technical contributions to computer functionality, including the creation and use of new machine learning models targeted to rare elements within a domain. In particular, systems and methods are disclosed herein that implement machine learning training, alignment, and inference techniques to improve the performance and applicability of machine learning models with respect to targeted features within a domain. By doing so, the techniques of the present disclosure enable improved machine learning performance and enable the application of machine learning to features that traditionally lacked sufficient information to apply inference operations. This, in turn, may improve the functionality of a computer with respect to various computing tasks, including data security, machine learning training, network communication, and the like, all of which are associated with rare features that a traditionally too rare to apply conventional machine learning techniques.

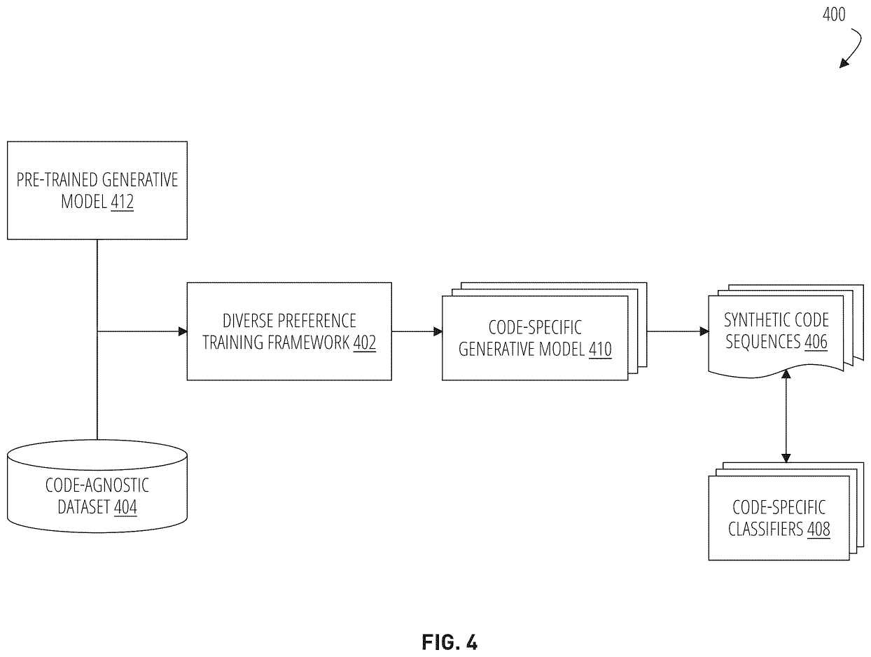

FIG. 4 is a dataflow diagram of synthetic data driven training scheme 400 in accordance with some embodiments of the present disclosure. A computing system, such as the computing system 101, may execute the synthetic data driven training scheme 400 to generate code-specific classifiers 408 that may be trained for underrepresented data elements, such as codes in various contexts, by supplementing limited real world observations with realistic synthetic data that accurately aligns with the limited real world observations. To do so, the computing system 101, and/or another system, may align a pre-trained generative model 412 with up to each of a set of target codes within a code-agnostic dataset 404 using a direct preference training framework 402. Unlike traditional preference training techniques, the direct preference training framework 402 may be leveraged to train the pre-trained generative model 412 for a particular element, or target code, rather than subjective preferences. By doing so, the direct preference training framework 402 may be applied to generate variations of code-specific generative models 410 from a single base model (e.g., the pre-trained generative model 412) that are each tailored to the nuances of an underrepresented element within a code-agnostic dataset 404. This enables specialization techniques for generative models that enables the creation of code-specific generative models 410 that tailor their generative outputs to the nuances of an underrepresented portion of an original dataset. This, in turn, allows for the generation of improved training data that may be applied to improve the accuracy and applicability of downstream classifiers with respect to rare data elements that traditionally lack sufficient data for training machine learning classifiers.

In some embodiments, the computing system 101 trains, or aligns, a pre-trained generative model 412 using a code-agnostic dataset 404 and a direct preference training framework 402 to generate a code-specific generative model 410.

In some embodiments, the pre-trained generative model 412 comprises a foundational model, a language model, and/or any generative model that is pre-trained on a large dataset to learn general patterns and representations. A pre-trained generative model 412, for example, may comprise a baseline (or bootstrapped) model that may serve as a starting point for one or more fine-tuning and/or alignment training tasks that may be specific to a particular domain. In this regard, the pre-trained generative model 412 used by the direct preference training framework 402 of the present disclosure may depend on the type of data within a target domain. By way of example, in a clinical, computer security, or other domain that handles structured data (e.g., clinical codes, security error codes), the pre-trained generative model 412 may comprise a generative model that is configured for structured data. As another example, in a text-processing domain that handles natural language text or an image processing domain that handles imagery, the pre-trained generative model 412 may comprise a generative model that handles natural language text, or images, respectively.

As one example, the pre-trained generative model 412 may comprise a CHIRon model, as described by U.S. application Ser. No. 18/477,359, which is incorporated by reference herein for all purposes. For instance, the pre-trained generative model 412 may comprise a decoder-only generative foundation model designed for structured sequential data, such as structure medical data (e.g., a sequence of clinical codes), structured network data (e.g., a sequence error codes), and/or the like. By way of example, the pre-trained generative model 412 may comprise a language model that may tokenize a set of codes within a particular domain (e.g., diagnosis, procedure, and medication codes along with lab results and other metadata such as patient demographics in a clinical domain) in addition to and/or instead of a set of character grams.

In any domain, the pre-trained generative model 412 may comprise a neural network, such as a transformer architectures. This pre-trained generative model 412, for example, may comprise one or more layers of tokenizer, embedding, and/or self-attention mechanisms and/or feedforward neural networks. In some examples, the pre-trained generative model 412 parameters may be stored in computer memory and accessed to process an input (e.g., a code sequence) with respect to a generative task (e.g., synthetic data generation). By way of example, the pre-trained generative model 412 may receive a sequence of tokens (e.g., tokenized from a code sequence) as input and may be trained to predict the next token in the sequence. In this way, the pre-trained generative model 412 may be trained to generate new token sequences (e.g., synthetic code sequences) that align with patterns represented within a training dataset, such as the code-agnostic dataset 404 of the present disclosure.

In some examples, the pre-trained generative model 412 may be leveraged as a starting point for the synthetic data driven training scheme 400. For example, the pre-trained generative model 412 may provide a strong foundation of general knowledge about the relationships between codes, events, and/or other data represented within a particular domain. As described herein, such general knowledge may accurately reflect both a sequence and frequency of each data element occurring within a domain, which may reduce the accuracy and/or frequency of generation, by the pre-trained generative model 412, of underrepresented data elements within the domain. While accurate, such deficiencies may reduce the applicability or usefulness of a pre-trained generative model 412 with respect to rare occurrences within a domain. To address this deficiency, the synthetic data driven training scheme 400 may implement the direct preference training framework 402 to refine the pre-trained generative model 412 with respect to target codes that may be underrepresented within an original dataset, such as the code-agnostic dataset 404 used to at least partially train the pre-trained generative model 412.

In some embodiments, the computing system 101 receives or accesses the code-agnostic dataset 404 for a particular domain to perform the synthetic data driven training scheme 400. The code-agnostic dataset 404 may comprise a set of code sequences that may be derived from real world observations, generic synthetic data generation processes, and/or the like, and/or is designed to represent a realistic code distribution within a particular domain.

In some embodiments, the code-agnostic dataset 404 comprises a historical and/or synthetic dataset of data entries that represent a set of anticipated or observed events within a real world environment. In some examples, the code-agnostic dataset 404 may provide a foundation for training the pre-trained generative model 412, one or more code-specific classifiers 408, and/or the like, by recording and/or simulating one or more real world patterns that may be learned by the trained models through unsupervised, supervised, semi-supervises, and/or any other training techniques.

In some examples, the code-agnostic dataset 404 may comprise a structed dataset of a set of structured data entries, such as the code sequences of the present disclosure. For instance, the code-agnostic dataset 404 may be stored in a structured format, such as a relational database, a specialized time-series database optimized for sequential data, a graph database, and/or the like. In some examples, an entry in the code-agnostic dataset 404 may comprise a code sequence, which may comprise an ordered list of codes (e.g., medical diagnosis, procedure, or medication codes in a clinical domain) associated with a particular entity (e.g., a patient in a clinical domain) over time. In addition, or alternatively, the code-agnostic dataset 404 may comprise additional metadata, such as timestamps, demographics, lab values, or other information for a particular entity that may be relevant for a particular domain.

The code-agnostic dataset 404 may provide a realistic distribution of data entries (e.g., code sequences) for training and/or evaluating generative models and/or classifiers with respect to various tasks within a particular domain or agnostic to any domain. The code-agnostic dataset 404 may comprise real world data or, for example in privacy-preserving scenarios, the code-agnostic dataset 404 may comprise synthetic data that maintains the statistical properties of the original data without exposing individual-level information.

As described herein, a data entry of the code-agnostic dataset 404 may comprise a code sequence. A code sequence may comprise a structured event sequence, where each sequence S={E₁, E₂, E₃, . . . , E_{L}} may comprise events E₁ drawn from a predefined vocabulary for a particular domain. For example, the predefined vocabulary may define a set of codes for representing events within a particular domain. The codes, for example, may comprise clinical codes for representing clinical events in a clinical domain, error codes for representing security events in a computer security domain, and/or the like. In any domain, a code sequence may record a sequence of events and/or an order in which they occur and/or are recorded. For example, the code sequence may represent a series of medical events, diagnoses, procedures, and/or medications associated with a patient over time, a series of access requests, application timeouts, invalid entries associated with a computer over time, and/or the like.

To improve storage capacity by reducing the memory footprint of the code-agnostic dataset 404, a code sequence may be stored as a linked list, array, matrix, and/or the like of code identifiers, where each identifier corresponds to a specific event or code within the predefined vocabulary. By way of example, the code sequence may comprise an array of integers, strings, and/or the like, depending on the coding system used. In some examples, up to each code sequence may comprise and/or may be stored in association with metadata, such as timestamps for each code to capture the temporal aspect of the events, entity-level attributes to capture non-coded information, and/or the like.

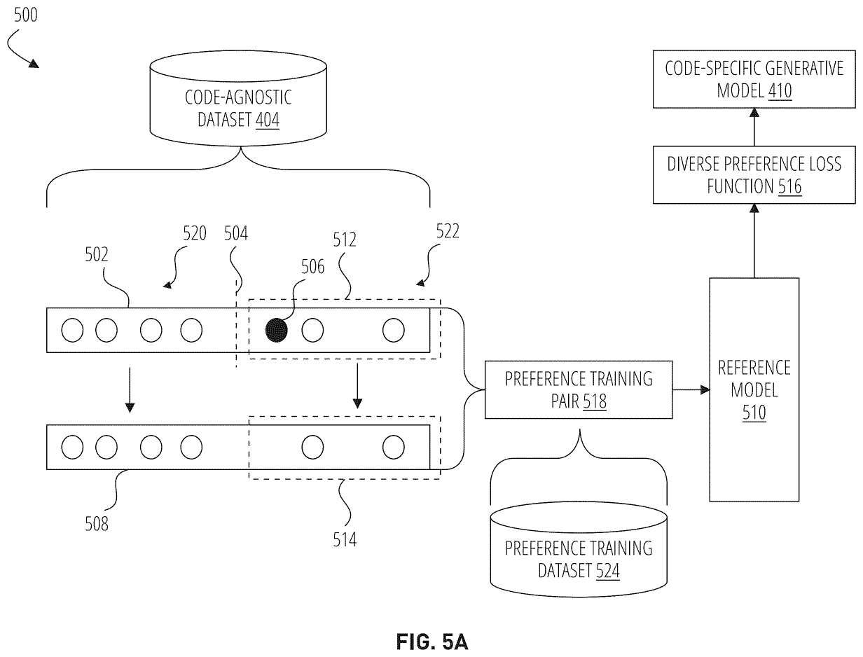

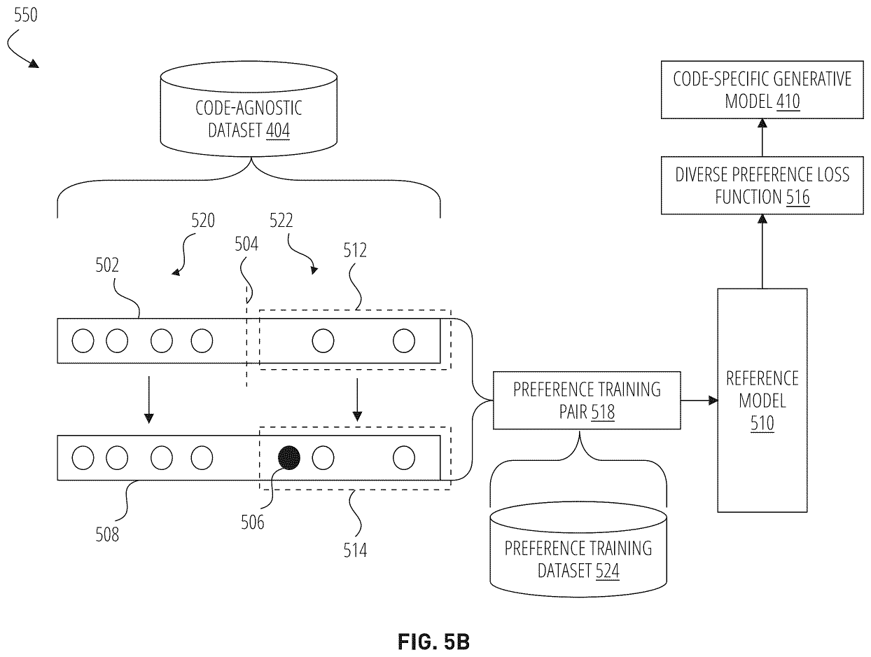

In some embodiments, the computing system 101 generates preference training pairs from the set of code sequences, as described with reference the operational examples of FIGS. 5A-B, to create a code-specific dataset that enhances the coverage of the code-agnostic dataset 404 with respect to a target code. In accordance with a direct preference training framework 402, the computing system 101 may train the pre-trained generative model 412, using the preference training pairs, to generate a code-specific generative model 410.

The direct preference training framework 402 comprises a training framework for aligning a pre-trained generative model 412 with a particular code within a code-agnostic dataset 404. To do so, the direct preference training framework 402 may define a two-stage approach that comprises (1) a preference data generation stage for generating a preference training dataset for a particular code, followed by (2) a preference alignment stage for aligning the pre-trained generative model 412 with the particular code using the preference training dataset. In some examples, through one or more iterations of the direct preference training framework 402, the direct preference training framework 402 may align a pre-trained generative model 412 with a set of target codes within the code-agnostic dataset 404 to generate a set of code-specific generative models 410 each tailored to a different code within the code-agnostic dataset 404. In some examples, a new iteration of the direct preference training framework 402 may be performed for up to each of a set of underrepresented codes (e.g., target codes) within the code-agnostic dataset 404 to generate code-specific generative models 410 for underrepresented portions of the code-agnostic dataset 404.

In some examples, through a two-staged approach, the direct preference training framework 402 may leverage preference training datasets and a direct preference loss function, as described with reference to FIGS. 5A-B, to implement a reward a signal to fine-tune a pre-trained generative model 412 initially trained on the autoregressive objective. The direct preference training framework 402 may leverage machine learning techniques, such as reinforcement learning, to refine the synthetic conditional distribution P(E_{target}|S_{context}) to closely match the real conditional distribution P(E_{target}|S_{context}), while minimizing disruptions to the overall sequence distribution P(S) learned during pre-training. To do so, the direct preference training framework 402 may generate preference training pairs from a code-agnostic dataset 404, as described herein with reference to FIGS. 5A-B, which provide rich training signals and allow for the adaptation of a direct preference loss function for a training objective. Using the direct preference loss function, the direct preference training framework 402 may train a pre-trained generative model 412 to learn the correct relationships between code sequences and underrepresented codes within the code-agnostic dataset 404. This, in turn, allows for the configuration of new code-specific generative model 410 that may be tailored to a particular code within the code-agnostic dataset 404.

The code-specific generative model 410, for example, may comprise generative model that has been trained using the direct preference training framework 402 to improve its performance with respect to a particular code (e.g., particularly rare or underrepresented codes) within the code-agnostic dataset 404. For example, a code-specific generative model 410 may be designed to learn a synthetic joint distribution P(S) that approximates the true distribution P(S), enabling the generation of synthetic sequences with improved accuracy for a target code.

The code-specific generative model 410 may comprise a finetuned variation of the pre-trained generative model 412. It may be implemented as a neural network (e.g., the same or similar architecture of the pre-trained generative model 412 with one or more different parameters, weights). In some examples, the weights, parameters, and/or other attributes of the code-specific generative model 410 may be stored in computer memory and/or may be updated during the training process using the direct preference training framework 402. For instance, the weights, parameters, and/or the like may be updated in one or more processing batches of preference training pairs by computing a reward signal using adverse preference loss function and/or adjusting the model weights through backpropagation and optimization algorithms (e.g., the direct preference loss function), as described herein.

The code-specific generative model 410 may be configured to received, as input, a prompt sequence of codes (e.g., a portion of a code sequence during training) and generates a continuation sequence. During inference, the code-specific generative model 410 may leverage techniques, such as autoregressive generation where each token is generated based on the previously generated tokens, to generate synthetic code sequences 406 based on the prompt. This process may involve sampling techniques, such as temperature scaling, top-k/top-p sampling to control the diversity and quality of the generated sequences, and/or the like. In this manner, the code-specific generative model 410 may be leveraged to generate synthetic code sequences 406 tailored to particular codes within the code-agnostic dataset 404 that may be used to train downstream code-specific classifiers 408 for particular the codes. By producing high-quality synthetic code sequences that accurately represent the relationships between particular codes and events, including rare event occurrences, the code-specific generative model 410 enables improved training of code-specific classifiers 408 that may predict and/or identify target codes in real-world data with increased accuracy, precision, and speed.

In some embodiments, the computing system 101 generates a code-specific generative model 410 for up to each of a set of target codes within the code-agnostic dataset 404. In some examples, the computing system 101 may identify the target code from the code-agnostic dataset 404 based on a code distribution for a set of codes represented within the code-agnostic dataset 404. The target code, for example, may comprise one of the set of codes that is associated with an underrepresented code within the code distribution.

In some embodiments, the target code is any code represented within a code-agnostic dataset 404. The target code, for example, may comprise a rare code that is underrepresented within a code-agnostic dataset 404 and may be a focus of the direct preference training framework 402 to improve the performance of subsequent classification tasks that suffer from limited data exposure. By way of example, a target code may be underrepresented within the code-agnostic dataset 404, making it challenging for code-specific classifiers 408 to accurately predict, identify, or assess a presence of a target code based on historical observations alone.

A target code may be represented as a specific identifier and/or token within the code vocabulary used in the code-agnostic dataset 404. In the context of medical coding, for example, the target code may comprise a particular diagnosis code (e.g., an ICD-10 code), procedure code (e.g., a CPT code), or medication code, and/or the like, which occurs infrequently in the data. In addition, or alternatively, in anomaly detection systems, target codes may comprise a particular error code that may represent rare but critical error states and/or security vulnerabilities that need to be accurately identified despite their infrequent occurrence in code-agnostic dataset 404. In any domain, the rarity of the target code may be determined by analyzing a code distribution within the code-agnostic dataset 404.

In some embodiments, the code distribution comprises a statistical distribution of codes within the code-agnostic dataset 404. The code distribution may represent the frequency and/or probability of occurrence for each code in the dataset. By way of example, the code distribution may comprise a set of count variables and/or hash tables to track code frequencies. In some example, the code distribution may comprise probability mass function, where each code is associated with its probability of occurrence in the dataset, and/or the like. In this manner, the code distribution may identify underrepresented codes through a low frequency metric (e.g., a frequency under a particular threshold (e.g., 10, 100, 1000)), a low probability of occurrence (e.g., general probability of occurrence under a particular threshold (e.g., 5%)), and/or the like.

In some embodiments, the computing system 101 generates, using the code-specific generative model 410, synthetic code sequences 406 for training a code-specific classifiers 408 for a target code. A synthetic code sequences 406, for example, may comprise an artificially generated sequence of codes that may be output by a generative model, such as the code-specific generative model 410. The synthetic code sequences 406 may be designed to mimic the properties and distributions of real-world code sequences, while addressing issues of data scarcity or imbalance, such as for target codes that may be underrepresented within a code-agnostic dataset 404. By way of example, a synthetic code sequence 406 may comprise an artificial code sequence that may be generated by the code-specific generative model 410, which uses its learned probability distributions to produce new sequences that are statistically similar to the sequences within the code-agnostic dataset with a particular focus on a target code. The generation process may involve an autoregressive prediction, where each code in the sequence is conditionally generated based on the preceding codes.

In some examples, up to each code-specific generative model 410 may generate a set of synthetic code sequences 406 for training a code-specific classifier 408 for a particular code. In this way, using the direct preference training framework 402, the computing system 101 may train a set of code-specific classifiers 408 with increased performance (e.g., in terms of accuracy, precision, speed) with respect to target codes (e.g., underrepresented or rare codes) within a code-agnostic dataset 404. A code-specific classifier 408, for example, may comprise a machine learning model that is trained to detect, identify, assign, and/or validate a particular code within an input entry (e.g., an input code sequence). For example, a code-specific classifier 408 may comprise a supervised (or unsupervised) machine learning model that may be trained to predict and/or identify the presence of specific codes within a given context. In some examples, the code-specific classifier 408 for a particular target code may comprise a neural network, decision tree, or ensemble methods, such as random forests, gradient boosting machines, and/or the like. By way of example, the code-specific classifiers 408 may comprise one or more individually trained Catboost classifiers, each of which may comprise a gradient boosting framework trained with respect to a target code within a domain.

In some examples, a code-specific classifier 408 may be trained using supervised learning techniques, which may involve presenting the model with input-output pairs (e.g., a synthetic code sequence with a target removed and a positive and/or negative label indicating whether the target code was removed) and optimizing its parameters to minimize a loss function (e.g., cross-entropy loss for binary classification). In this manner, the up to each of the code-specific classifiers 408 may be trained, using the synthetic code sequences, to predict the presence of specific codes in new, unseen data. By training on synthetic code sequences generated by the code-specific generative model 410, the code-specific classifiers 408 may achieve improved accuracy, precision, and speed with respect to target codes that are typically outside the scope of classifier model due to limitations in available training data.

FIGS. 5A-B are operational examples of the direct preference training framework in accordance with some embodiments of the present disclosure. FIG. 5A, for example, depicts a first operational example 500, in which a target code 506 is present within a code sequence of the code-agnostic dataset 404. FIG. 5B depicts a second operational example 550, in which a target code 506 is absent from the code sequence of the code-agnostic dataset 404. With reference to FIGS. 5A and 5B, in some embodiments, the computing system 101, in accordance with the direct preference training framework, generates a preference training pair 518 from a code sequence of the set of code sequences within the code-agnostic dataset 404. The preference training pair 518 may be added to a preference training dataset 524 for finetuning a pre-trained generative model 412 with respect to a target code 506.

In some embodiments, the preference training dataset 524 comprises a sample dataset that is configured for a particular preference, which in this case may be a preference towards a target code within the code-agnostic dataset 404. To do so, the preference training dataset 524 may comprise a set of preference training pairs specific to the target code, designed to capture and emphasize the correct relationships between codes sequences and the rare occurrence of the target code within the code-agnostic dataset 404.

In some embodiments, a preference training pair 518 comprises a pair of code sequences derived from a code sequence within the code-agnostic dataset 404. Up to each preference training pair 518 within the code-agnostic dataset 404 may comprise a positive training preference sample 502 that accurately reflects the code sequence and/or a negative training preference sample 508 that is perturbed from the code sequence and is designed to provide a contrastive learning signal for the direct preference training framework 402.

In some embodiments, the computing system 101 generates the preference training pair 518 by splitting a code sequence into a prompt sequence 520 and a continuation sequence 522. The prompt sequence 520, for example, may comprise a first portion of the code sequence that may be used as a prompt during the direct preference training framework. For instance, the prompt sequence may represent an initial portion of a code sequence that provides context for a subsequent generation and/or prediction task. The continuation sequence 522 may comprise a second portion of a code sequence that is used as a label during the direct preference training framework 402. For instance, the continuation sequence 522 may represent a latter part of a code sequence that code-specific generative model 410 is trained to generate or predict given the corresponding prompt sequence 520.

In some embodiments, a prompt sequence 520 comprises a subset of the original code sequence, containing a first j elements where j may be defined by a split point 504. The prompt sequence 520 may be stored as a slice or subarray of the original code sequence data structure. In some examples, the prompt sequence 520 may be stored in association with additional metadata, such as a length of the prompt sequence 520, an index of the split point 504 within the code sequence, and/or the like. The prompt sequence 520 may be used as input context to the code-specific generative model 410 to provide the context from which the code-specific generative model 410 may learn to generate and/or predict the synthetic continuation sequences. In some examples, during inference, prompt sequences 520 may serve as context to the finetuned code-specific generative model 410 to generate synthetic code sequences, allowing the model to produce contextually appropriate and diverse synthetic data with respect to a particular target code 506.

In some embodiments, a continuation sequence 522 comprises a subset of the original code sequence, containing one or more elements from the split point 504 to the termination of the code sequence. The continuation sequence 522 may be stored as a slice or subarray of the original code sequence data structure. In some examples, the continuation sequence 522 may be stored in association with additional metadata, such as a length of the continuation sequence 522, an index of the split point 504 within the code sequence, and/or the like. The continuation sequence 522 may serve as the target output or label during a training phase of the direct preference training framework. During training, the code-specific generative model 410 may learn to generate synthetic continuation sequences given the corresponding prompt sequences 520 that align with the continuation sequences 522. During evaluation and inference, synthetic continuation sequences 522 may be compared against the true continuation sequences 522 to assess the model's performance and to create synthetic code sequences.

In some examples, the computing system 101 may split the code sequence into the prompt sequence 520 and the continuation sequence 522 based on a split point 504. In some examples, the computing system 101 may determine the split point 504 based on a presence of the target code 506 within the code sequence. By way of example, the computing system 101 may, in response to detecting the presence of the target code 506 within the code sequence, determine a target index of the target code 506 within the code sequence, determine a subrange of the code sequence based on the target index, and determine the split point 504 by randomly selecting an index from the subrange. In addition, or alternatively, in response to detecting an absence of the target code 506 within the code sequence, the computing system 101 may determine the split point by randomly selecting an index from a range of the code sequence.

In some embodiments, the split point 504 comprises an integer index within the original code sequence. The integer index, for example, may mark the boundary between the prompt sequence 520 (e.g., elements before the split point 504) and the continuation sequence 522 (e.g., elements after the split point 504). In some examples, the integer index may be randomly samples from an index sampling range. The index sampling range, for example, may comprise a defined range that may ensure a required number of elements (e.g., 2, 4, 10, 100) a prompt sequence 520 and/or continuation sequence 522. In some examples, the index sampling range may be defined by a target index at which a target code 506 is present within the code sequence. For instance, a terminal index of the index sampling range may be defined by the target index, ensuring that any target code 506 is split into a continuation sequence 522 rather than the prompt sequence 520. In addition, or alternatively, the integer index may comprise an index immediately preceding the target index.

In some embodiments, the computing system 101 generates a positive training preference sample 502 of the preference training pair 518 based on the prompt sequence 520 and/or the continuation sequence 522, which is a positive sequence 512 that realistically represents the original code sequence. For example, a positive sequence may comprise a continuation sequence that is positively labeled as representing an observed continuation sequence from a code sequence. For instance, the positive sequence may represent a correct and/or desired continuation of a prompt sequence 520 with respect to the presence and/or absence of the target code 506. In some examples, the positive sequence 512 may be denoted as C in the present disclosure, representing the preferred sequence in a direct preference loss function 516.

In some embodiments, the positive training preference sample 502 comprises the original code sequence that is unperturbed and accurately reflects the presence of a target code 506 within the original code sequence. The positive training preference sample 502 serves as the preferred example in the preference training pair 518, representing the correct relationship between the prompt sequence 520 and the presence (or absence) of the target code 506 within the continuation sequence 522.

The computing system 101 generates a negative training preference sample 508 of the preference training pair 518 based on the prompt sequence 520 and a negative sequence 514. The negative sequence 514, for example, may be generated by modifying a presence of the target code 506 within the continuation sequence 522.

In some embodiments, a negative sequence 514 is a continuation sequence 522 that is negatively labeled as representing an incorrect and/or less desirable continuation of a prompt sequence 520 with respect to the presence and/or absence of the target code 506. A negative sequence 514 may be generated by intentionally altering the presence and/or absence of the target code 506 within the continuation sequence 522 to provide targeted noise to the continuation sequence 522 with respect to the target code 506. In some examples, the negative sequence 514 may be denoted as R in the present disclosure, representing the rejected sequence in a direct preference loss function 516.

As described herein, negative sequences may be used in conjunction with positive sequences 512 in the direct preference training framework to provide contrastive examples of a learning object for the code-specific generative model 410. For example, using a learning objective of the direct preference loss function 516, the code-specific generative model 410 may be trained to avoid and/or assign lower probabilities when generating synthetic data similar to negative sequences 514 by contrasting negative sequences 514 with the positive sequences 512 of the positive training preference sample 502. In this way, the code-specific generative model 410 may learns to distinguish between appropriate and inappropriate contexts for the target code, enhancing its ability to generate realistic and accurate synthetic samples.

In some embodiments, the negative training preference sample 508 is a perturbed code sequence that inaccurately reflects the presence of a target code 506 within the original code sequence. The negative training preference sample 508, for example, may comprise the prompt sequence 520 and/or the negative sequence 514, which may be perturbed by either removing and/or adding a target code 506 to introduce targeted noised that disrupts the accuracy of the code-specific classifiers 408 with respect to a particular target code 506.

In some embodiments, the direct preference training framework implements a different perturbation technique for a preference training pair 518 based on the presence or absence of a target code 506 within the original code sequence. A first perturbation technique, as reflected by the operational example 500 of FIG. 5B, may be applied in response to a detection of the presence of the target code 506 within the code sequence. For example, in accordance with the first perturbation technique, the computing system 101 may, in response to a detection of the presence of the target code 506 within the continuation sequence 522, remove the target code 506 from the continuation sequence 522 to generate the negative sequence 514, as reflected by operational example 500. In this manner, a target code 506 may be removed to disrupt the accuracy of the negative sequence 514 with respect to the target code 506, without impacting other codes within the negative training preference sample 508. In this way, the first perturbation technique of the operational example 500, may perform a reductive perturbations to apply targeted noise to the negative training preference sample 508.

In addition, or alternatively, a second perturbation technique, as reflected by the operational example 550 of FIG. 5B, may be applied in response to a detection of an absence of the target code 506 within the code sequence. For example, in accordance with the second perturbation technique, the computing system 101 may, in response to a detection of the absence of the target code 506 within the continuation sequence 522, add the target code 506 to the continuation sequence 522 to generate the negative sequence 514, as reflected by operational example 550. In this manner, a target code 506 may be added to disrupt the accuracy of the negative sequence 514 with respect to the target code 506, without impacting other codes within the negative training preference sample 508. In this way, the second perturbation technique of the operational example 550, may perform additive perturbations to apply targeted noise to the negative training preference sample 508.

In some examples, the computing system 101 may add the target code 506 to the continuation sequence 522 by inserting the target code 506 at a randomly selected insertion point within the continuation sequence 522. The insertion point, for example, may comprise an index at which a target code 506 may be is added within a continuation sequence 522 to create a negative sequence 514. In some examples, the insertion point may be represented as an integer index (e.g., separate from the split point 504) within the continuation sequence 522. The insertion point may comprise a randomized index to ensure diversity in the negative samples. For instance, the computing system 101 may randomly sample (e.g., using a random number generator) the integer index from a subrange of the code sequence that corresponds to the continuation sequence 522. In addition, or alternatively, the insertion split point 504 may be determine using one or more constraints and/or heuristics to ensure diversity (e.g., by ensuring even distributions of placement positions) between negative sequences 514 of the preference training dataset 524.

In some embodiments, the computing system 101 trains the pre-trained generative model 412 to generate the code-specific generative model 410 using a direct preference loss function 516, the preference training pair 518, and/or a reference model 510. The direct preference loss function 516, for example, may comprise a direct preference optimization (DPO-plus) function.

In some embodiments, the direct preference loss function 516 is a training function used in machine learning to optimize a model's performance with respect to a preference training dataset 524. The direct preference loss function 516, for example, may be designed to guide a learning process of a pre-trained generative model 412 to improve the model's ability with respect to a particular preference within domain. Here, the direct preference loss function 516 is adapted to a finetuning technique for a particular target code 506 that may be underrepresented within a code-agnostic dataset 404.

The direct preference loss function 516 may be implemented as part of a reinforcement learning pipeline that leverage pairs of data samples (e.g., preference training pairs 518), where one sample (e.g., positive training preference sample 502) is preferred over the other (e.g., negative training preference sample 508) to adjust a model's parameters to align with the preferences exhibited by the contrastive examples. To do so, the direct preference loss function 516 may capture a difference between the model's current output (e.g., as represented by a reference model 510) and the desired output (e.g., as represented by the positive training preference sample 502).

The direct preference loss function 516 may comprise any reference model-based and/or reference model-less preference training function. For example, the direct preference loss function 516 may comprise a direct preference optimization function, such as DPP-plus that may directly use preference-labeled data without requiring a reward model. By way of example, the direct preference loss function 516 may be denoted as:

$$L ( {π}_{θ} ; {π}_{r e f} = - {𝔼}_{( P , C , R ) ∼ D} [ log σ ( β log \frac{{π}_{θ} ( C \vert P )}{{π}_{ref} ( C \vert P )} - β log \frac{{π}_{θ} ( R \vert P )}{{π}_{ref} ( R \vert P )} ) ] - λ \cdot max ( 0 , log \frac{{π}_{ref} ( C \vert P )}{{π}_{θ} ( C \vert P )} )$$

where P may represent a code sequence, C may represent a positive sequence, and R may represent a negative sequence and wherein D may be the distribution of preference labeled data within the preference training dataset 524. In some examples, the direct preference loss function 516 may introduce a regularization term to ensure the model not only reduces the likelihood of rejected sequences R, but also maintains the likelihood of preferred sequences C. In some examples, the hyperparameter λ=0.1 may be used to control the regularization strength.

In this manner, the direct preference loss function 516 may implement a reference model-based alignment technique that may not require fitting a reward model and uses simpler binary data preferences for training. In addition, or alternatively, it may be computationally lighter weight and faster than traditional human in the loop reinforcement training, while being equally effective at alignment. In the direct preference loss function 516 π_{θ}(C|P) and π_{θ}(R|P) may represent the probabilities that the model, parameterized by θ, assigns to specific responses (C for an upper or preferred response, and R for a lower or less preferred response) given an input P. π_{ref}(C|P) and π_{ref}(C|P) may represent the probabilities given by a reference policy or the reference model 510 (e.g., a baseline model, such as the pre-trained generative model 412 of FIG. 4) for the same responses to the same input. This helps in gauging how much the current model's predictions deviate from a baseline. The term

$$β log \frac{{π}_{θ} ( C \vert P )}{{π}_{ref} ( C \vert P )} - βlog$$

$$\frac{{π}_{θ} ( R \vert P )}{{π}_{ref} ( R \vert P )}$$

may represent an optimization function, wherein the model updates itself to increase the probability of the positive sequence 512 (C) relative to the baseline while decreasing the probability of the negative sequence 514 (R). The β coefficient may acts as a balancing factor, determining how strongly the model should adhere to or deviate from the reference behavior. The term E[ . . . ] may indicate that the expected value of the inside expression across all inputs and outputs may be taken as a reward when averaging out the adjustments across all scenarios the model encounters to find the optimal overall behavior with respect to the target code 506.

In some embodiments, the computing system 101 may fine-tune the pre-trained model using a plurality of preference training pairs 518 from the preference training dataset 524, reinforcing its ability to generate target codes 506 based on a limited historical sample size of the target code 506. In some examples, the preference training dataset 514 may comprise a threshold number of preference training pairs 518. The threshold number of preference training pairs 518, for example, may be set by a code sample size threshold that may comprise a static (e.g., 100,000) or dynamic (e.g., 100 times the size of the sample size of the target code within the code-agnostic dataset 404) based on the target code 506.

In some embodiments, a different code-specific generative model 410 is trained for up to each of a set of target codes within the code-agnostic dataset 404. For evaluation, an evaluation set may be selected from the code-agnostic dataset 404, up to each code sequence of the evaluation set may be truncated by a set number of codes (e.g., T), and the remaining codes may be used to prompt the code-specific generative model 420 to generate the truncated set of codes. The code-specific generative model 420 performance may be evaluated based at least on (1) its ability to correctly generate the target codes, and/or (2) the utility of its synthetic data for a classification task. By way of example, the performance of the code-specific generative model 410 may be based on the performance of a downstream code-specific classifier.

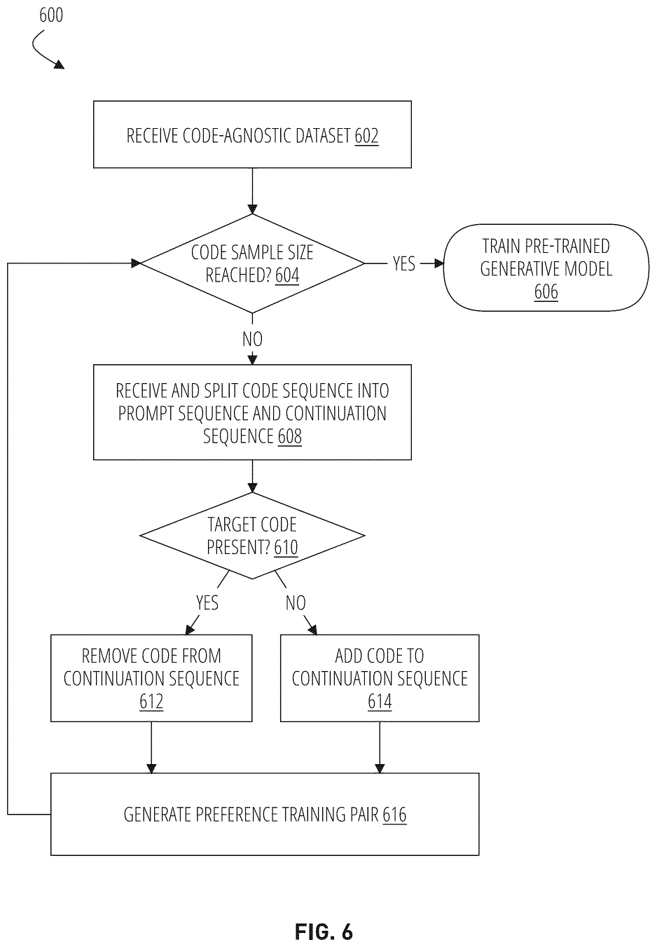

FIG. 6 is a flowchart diagram of a direct preference training process 600 in accordance with some embodiments of the present disclosure. The flowchart diagram depicts a training and/or model alignment process that adapts a reinforcement-based preference alignment approach to a training process for targeting underrepresented features within a domain. The process 600 may be implemented by one or more computing devices, entities, and/or systems described herein. For example, via the various steps/operations of the process 600, the computing system 101 may generate a preference training dataset from code-agnostic dataset that is designed to align a pre-trained generative model with an underrepresented code within the code-agnostic dataset. By doing so, the process 600 allows for the alignment of language models with underrepresented features within a dataset, which improves computer functionality by improving the performance (e.g., in terms of accuracy and applicability) of synthetic data generation with respect to underrepresented data feature, where synthetic data is needed most for machine learning training. This, in turn, enables improved machine learning training operations for downstream classifiers that traditionally lacked accuracy and precision due to data deficiencies of underrepresented data features.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 comprises, at operation 602, receiving a code-agnostic dataset. For example, the computing system 101 may receive the code-agnostic dataset comprising a set of code sequences. In some examples, the computing system 101 may identify a target code from the code-agnostic dataset based on a code distribution for a set of codes represented within the code-agnostic dataset. The target code, for example, may comprise one of the set of codes that is associated with an underrepresented code within the code distribution.

In some embodiments, the process 600 comprises, at operation 604, determining a code sample size for a target code. For example, the computing system 101 may determine the code sample size based on a number of available code sequences and/or preference training pairs for a target code. In response to the code sample size meeting or exceeding an alignment threshold (e.g., 1000 samples) for training a pre-trained generative model, the process 600 may proceed to operation 606. Otherwise, the process 600 may proceed to operation 608.

In some embodiments, the process 600 comprises, at operation 608, receiving and splitting a code sequence into a prompt sequence and continuation sequence. For example, the computing system 101 may split the code sequence into a prompt sequence and a continuation sequence. In some examples, the computing system 101 may determine a split point based on a presence of the target code within the code sequence and split the code sequence into the prompt sequence and the continuation sequence based on the split point. By way of example, the computing system 101 may, in response to detecting the presence of the target code within the code sequence, determine a target index of the target code within the code sequence, determine a subrange of the code sequence based on the target index, and determine the split point by randomly selecting an index from the subrange. In addition, or alternatively, in response to detecting an absence of the target code within the code sequence, the computing system 101 may determine the split point by randomly selecting an index from a range of the code sequence.

The computing system 101 may generate a positive training preference sample of the preference training pair based on the prompt sequence and the continuation sequence. The computing system 101 may generate a negative training preference sample of the preference training pair based on the prompt sequence and a negative sequence. The negative sequence, for example, may be generated by modifying a presence of the target code within the continuation sequence in accordance with at least one of operation 612 or operation 614.

In some embodiments, the process 600 comprises, at operation 610, determining whether a target code is present within the code sequence. In response to the determination that a target code is present within the code sequence, the process 600 may proceed to operation 612. Otherwise, the process 600 may proceed to operation 614.

In some embodiments, the process 600 comprises, at operation 612, removing the target code from the continuation sequence to generate a negative sequence for a preference training pair. For example, the computing system 101 may, in response to a detection of the presence of the target code within the continuation sequence, remove the target code from the continuation sequence to generate the negative sequence.

In some embodiments, the process 600 comprises, at operation 614, adding the target code to the continuation sequence to generate a negative sequence for a preference training pair. For example, the computing system 101 may, in response to a detection of an absence of the target code within the continuation sequence, adding the target code to the continuation sequence to generate the negative sequence. In some examples, the computing system 101 may add the target code to the continuation sequence by inserting the target code at a randomly selected insertion point within the continuation sequence.

In some embodiments, the process 600 comprises, at operation 616, generating the preference training pair. For example, the computing system 101 may generate the preference training pair from a code sequence of the set of code sequences based on the positive training preference sample and the negative training preference sample generated in accordance with at least one of operation 612 or operation 614.

In some embodiments, the process 600 comprises, at operation 606, training the pre-trained generative model. For example, the computing system 101 may train, using a direct preference loss function and the preference training pair, a pre-trained generative model to generate the code-specific generative model. In some examples, the direct preference loss function may comprise a direct preference optimization (DPO-plus) function.

In some embodiments, the computing system 101 generates, using the code-specific generative model, a synthetic code sequence for training a code-specific classifier for a target code.

Some techniques of the present disclosure enable the generation of action outputs that may be performed to initiate one or more real world actions to achieve real-world effects. The techniques of the present disclosure may be used, applied, and/or otherwise leveraged generate synthetic data and/or code predictions in various domains. In some examples, the synthetic data, and/or code predictions based thereon, of the present disclosure may trigger action outputs (e.g., through control instructions) to automate a computer, a robotic device, a medical diagnostic and/or injection device, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### IV. Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### V. Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising generating, by one or more processors and using a code-specific generative model, a synthetic code sequence for training a code-specific classifier for a target code, wherein the code-specific generative model is trained by (i) receiving a code-agnostic dataset comprising a set of code sequences, (ii) generating a preference training pair from a code sequence of the set of code sequences by (a) splitting the code sequence into a prompt sequence and a continuation sequence, (b) generating a positive training preference sample of the preference training pair based on the prompt sequence and the continuation sequence, and (c) generating a negative training preference sample of the preference training pair based on the prompt sequence and a negative sequence, wherein the negative sequence is generated by modifying a presence of the target code within the continuation sequence, and (iii) training, using a direct preference loss function and the preference training pair, a pre-trained generative model to generate the code-specific generative model.

Example 2. The computer-implemented method of example 1, wherein modifying the presence of the target code within the continuation sequence comprises, in response to a detection of the presence of the target code within the continuation sequence, removing the target code from the continuation sequence to generate the negative sequence.

Example 3. The computer-implemented method of any of the preceding examples, wherein modifying the presence of the target code within the continuation sequence comprises, in response to a detection of an absence of the target code within the continuation sequence, adding the target code to the continuation sequence to generate the negative sequence.

Example 4. The computer-implemented method of example 3, wherein adding the target code to the continuation sequence to generate the negative sequence comprises inserting the target code at a randomly selected insertion point within the continuation sequence.

Example 5. The computer-implemented method of any of the preceding examples, wherein splitting the code sequence into the prompt sequence and the continuation sequence comprises determining a split point based on a presence of the target code within the code sequence; and splitting the code sequence into the prompt sequence and the continuation sequence based on the split point.

Example 6. The computer-implemented method of example 5, wherein, in response to detecting the presence of the target code within the code sequence, the computer-implemented method comprises determining a target index of the target code within the code sequence; determining a subrange of the code sequence based on the target index; and determining the split point by randomly selecting an index from the subrange.

Example 7. The computer-implemented method of examples 5 of 6, wherein, in response to detecting an absence of the target code within the code sequence, the computer-implemented method comprises determining the split point by randomly selecting an index from a range of the code sequence.

Example 8. The computer-implemented method of any of the preceding examples, wherein the direct preference loss function comprises a direct preference optimization (DPO-plus) function.

Example 9. The computer-implemented method of any of the preceding examples, further comprising identifying the target code from the code-agnostic dataset based on a code distribution for a set of codes represented within the code-agnostic dataset.

Example 10. The computer-implemented method of example 9, wherein the target code is one of the set of codes that is associated with an underrepresented code within the code distribution.

Example 11. A system comprising one or more processors; and one or more memories storing processor-executable instructions that, when executed by the one or more processors, cause the one or more processors to perform operations comprising generating, using a code-specific generative model, a synthetic code sequence for training a code-specific classifier for a target code, wherein the code-specific generative model is trained by (i) receiving a code-agnostic dataset comprising a set of code sequences, (ii) generating a preference training pair from a code sequence of the set of code sequences by (a) splitting the code sequence into a prompt sequence and a continuation sequence, (b) generating a positive training preference sample of the preference training pair based on the prompt sequence and the continuation sequence, and (c) generating a negative training preference sample of the preference training pair based on the prompt sequence and a negative sequence, wherein the negative sequence is generated by modifying a presence of the target code within the continuation sequence, and (iii) training, using a direct preference loss function and the preference training pair, a pre-trained generative model to generate the code-specific generative model.

Example 12. The system of example 11, wherein modifying the presence of the target code within the continuation sequence comprises, in response to a detection of the presence of the target code within the continuation sequence, removing the target code from the continuation sequence to generate the negative sequence.

Example 13. The system of example 11 or 12, wherein modifying the presence of the target code within the continuation sequence comprises, in response to a detection of an absence of the target code within the continuation sequence, adding the target code to the continuation sequence to generate the negative sequence.

Example 14. The system of example 13, wherein adding the target code to the continuation sequence to generate the negative sequence comprises inserting the target code at a randomly selected insertion point within the continuation sequence.

Example 15. The system of any of examples 11 through 14, wherein splitting the code sequence into the prompt sequence and the continuation sequence comprises determining a split point based on a presence of the target code within the code sequence; and splitting the code sequence into the prompt sequence and the continuation sequence based on the split point.

Example 16. The system of example 15, wherein, in response to detecting the presence of the target code within the code sequence, the operations further comprise determining a target index of the target code within the code sequence; determining a subrange of the code sequence based on the target index; and determining the split point by randomly selecting an index from the subrange.

Example 17. The system of example 15 or 16, wherein, in response to detecting an absence of the target code within the code sequence, the operations further comprise determining the split point by randomly selecting an index from a range of the code sequence.

Example 18. One or more non-transitory computer-readable media storing processor-executable instructions that, when executed by one or more processors, cause the one or more processors to perform operations comprising generating, using a code-specific generative model, a synthetic code sequence for training a code-specific classifier for a target code, wherein the code-specific generative model is trained by (i) receiving a code-agnostic dataset comprising a set of code sequences, (ii) generating a preference training pair from a code sequence of the set of code sequences by (a) splitting the code sequence into a prompt sequence and a continuation sequence, (b) generating a positive training preference sample of the preference training pair based on the prompt sequence and the continuation sequence, and (c) generating a negative training preference sample of the preference training pair based on the prompt sequence and a negative sequence, wherein the negative sequence is generated by modifying a presence of the target code within the continuation sequence, and (iii) training, using a direct preference loss function and the preference training pair, a pre-trained generative model to generate the code-specific generative model.

Example 19. The one or more non-transitory computer-readable media of example 18, wherein the direct preference loss function comprises a direct preference optimization (DPO-plus) function.

Example 20. The one or more non-transitory computer-readable media of example 18 or 19, wherein the operations further comprise identifying the target code from the code-agnostic dataset based on a code distribution for a set of codes represented within the code-agnostic dataset.

Example 21. The computer-implemented method of example 1, wherein the method further comprises training the code-specific generative model.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the code-specific generative model.

Example 25. The computing system of example 24, wherein the one or more processors are comprised in a first computing entity; and the code-specific generative model is trained by one or more other processors comprised in a second computing entity.

Example 26. The one or more non-transitory computer-readable storage media of example 18, wherein the instructions further cause the one or more processors to train the code-specific generative model.

Example 27. The one or more non-transitory computer-readable storage media of example 26, wherein the one or more processors are comprised in a first computing entity; and the code-specific generative model is trained by one or more other processors comprised in a second computing entity.

What is claimed is:

1. A computer-implemented method comprising:
generating, by one or more processors and using a code-specific generative model, a synthetic code sequence for training a code-specific classifier for a target code, wherein the code-specific generative model is trained by:
(i) receiving a code-agnostic dataset comprising a set of code sequences,
(ii) generating a preference training pair from a code sequence of the set of code sequences by:
(a) splitting the code sequence into a prompt sequence and a continuation sequence,
(b) generating a positive training preference sample of the preference training pair based on the prompt sequence and the continuation sequence, and
(c) generating a negative training preference sample of the preference training pair based on the prompt sequence and a negative sequence, wherein the negative sequence is generated by modifying a presence of the target code within the continuation sequence, and
(iii) training, using a direct preference loss function and the preference training pair, a pre-trained generative model to generate the code-specific generative model.

2. The computer-implemented method of claim 1, wherein modifying the presence of the target code within the continuation sequence comprises, in response to a detection of the presence of the target code within the continuation sequence, removing the target code from the continuation sequence to generate the negative sequence.

3. The computer-implemented method of claim 1, wherein modifying the presence of the target code within the continuation sequence comprises, in response to a detection of an absence of the target code within the continuation sequence, adding the target code to the continuation sequence to generate the negative sequence.

4. The computer-implemented method of claim 3, wherein adding the target code to the continuation sequence to generate the negative sequence comprises inserting the target code at a randomly selected insertion point within the continuation sequence.

5. The computer-implemented method of claim 1, wherein splitting the code sequence into the prompt sequence and the continuation sequence comprises:
determining a split point based on a presence of the target code within the code sequence; and
splitting the code sequence into the prompt sequence and the continuation sequence based on the split point.

6. The computer-implemented method of claim 5, wherein, in response to detecting the presence of the target code within the code sequence, the computer-implemented method comprises:
determining a target index of the target code within the code sequence;
determining a subrange of the code sequence based on the target index; and
determining the split point by randomly selecting an index from the subrange.

7. The computer-implemented method of claim 5, wherein, in response to detecting an absence of the target code within the code sequence, the computer-implemented method comprises determining the split point by randomly selecting an index from a range of the code sequence.

8. The computer-implemented method of claim 1, wherein the direct preference loss function comprises a direct preference optimization (DPO-plus) function.

9. The computer-implemented method of claim 1, further comprising identifying the target code from the code-agnostic dataset based on a code distribution for a set of codes represented within the code-agnostic dataset.

10. The computer-implemented method of claim 9, wherein the target code is one of the set of codes that is associated with an underrepresented code within the code distribution.

11. A system comprising:
one or more processors; and
one or more memories storing processor-executable instructions that, when executed by the one or more processors, cause the one or more processors to perform operations comprising:
generating, using a code-specific generative model, a synthetic code sequence for training a code-specific classifier for a target code, wherein the code-specific generative model is trained by:
(i) receiving a code-agnostic dataset comprising a set of code sequences,
(ii) generating a preference training pair from a code sequence of the set of code sequences by:
(a) splitting the code sequence into a prompt sequence and a continuation sequence,
(b) generating a positive training preference sample of the preference training pair based on the prompt sequence and the continuation sequence, and
(c) generating a negative training preference sample of the preference training pair based on the prompt sequence and a negative sequence, wherein the negative sequence is generated by modifying a presence of the target code within the continuation sequence, and
(iii) training, using a direct preference loss function and the preference training pair, a pre-trained generative model to generate the code-specific generative model.

12. The system of claim 11, wherein modifying the presence of the target code within the continuation sequence comprises, in response to a detection of the presence of the target code within the continuation sequence, removing the target code from the continuation sequence to generate the negative sequence.

13. The system of claim 11, wherein modifying the presence of the target code within the continuation sequence comprises, in response to a detection of an absence of the target code within the continuation sequence, adding the target code to the continuation sequence to generate the negative sequence.

14. The system of claim 13, wherein adding the target code to the continuation sequence to generate the negative sequence comprises inserting the target code at a randomly selected insertion point within the continuation sequence.

15. The system of claim 11, wherein splitting the code sequence into the prompt sequence and the continuation sequence comprises:
determining a split point based on a presence of the target code within the code sequence; and
splitting the code sequence into the prompt sequence and the continuation sequence based on the split point.

16. The system of claim 15, wherein, in response to detecting the presence of the target code within the code sequence, the operations further comprise:
determining a target index of the target code within the code sequence;
determining a subrange of the code sequence based on the target index; and
determining the split point by randomly selecting an index from the subrange.

17. The system of claim 15, wherein, in response to detecting an absence of the target code within the code sequence, the operations further comprise determining the split point by randomly selecting an index from a range of the code sequence.

18. One or more non-transitory computer-readable media storing processor-executable instructions that, when executed by one or more processors, cause the one or more processors to perform operations comprising:
generating, using a code-specific generative model, a synthetic code sequence for training a code-specific classifier for a target code, wherein the code-specific generative model is trained by:
(i) receiving a code-agnostic dataset comprising a set of code sequences,
(ii) generating a preference training pair from a code sequence of the set of code sequences by:
(a) splitting the code sequence into a prompt sequence and a continuation sequence,
(b) generating a positive training preference sample of the preference training pair based on the prompt sequence and the continuation sequence, and
(c) generating a negative training preference sample of the preference training pair based on the prompt sequence and a negative sequence, wherein the negative sequence is generated by modifying a presence of the target code within the continuation sequence, and
(iii) training, using a direct preference loss function and the preference training pair, a pre-trained generative model to generate the code-specific generative model.

19. The one or more non-transitory computer-readable media of claim 18, wherein the direct preference loss function comprises a direct preference optimization (DPO-plus) function.

20. The one or more non-transitory computer-readable media of claim 18, wherein the operations further comprise:
identifying the target code from the code-agnostic dataset based on a code distribution for a set of codes represented within the code-agnostic dataset.
